(19) United States
(12) Patent Application Publication
(10) Pub. No.: US 2021/0164515 A1
(43) Pub. Date: Jun. 3, 2021

(54) SWIVEL PAD CAPABLE OF AUTOMATICALLY RETURNING TO REFERENCE POINT

(71) Applicant: Jung Soo SON, Busan (KR)

(72) Inventor: Jung Soo SON, Busan (KR)

(21) Appl. No.: 17/104,565

(22) Filed: Nov. 25, 2020

(30) Foreign Application Priority Data
Nov. 29, 2019 (KR) 10-2019-0157629
Nov. 3, 2020 (KR) 10-2020-0145554

(51) Int. Cl. F16C 11/12; B25B 5/16; F16C 11/06

(52) U.S. Cl. CPC F16C 11/12; F16C 11/0695; B25B 5/163

(57) ABSTRACT

A swivel pad capable of automatically returning to a reference point, includes: a compression ball having top and bottom surfaces processed to be flat and having a first elastic body insertion hole; a support member configured to have one side in which an insertion groove for accommodating the compression ball is formed, and a first return space and a second elastic body insertion hole having a predetermined depth in a center of the first return space are formed below the insertion groove, and configured to have an opposite side formed with a connection portion connected to a clamp; and an elastic member having ends inserted into the first elastic body insertion hole and the second elastic body insertion hole, respectively, to support the compression ball, wherein the top surface of the compression ball compresses a workpiece to fix or move the workpiece.

### BACKGROUND OF THE INVENTION

### 1. Field of the Invention

The present invention relates to a swivel pad capable of automatically returning to a reference point, and more particularly, to a swivel pad capable of automatically returning to a reference point to operate from various angles to effectively fix or support an uneven workpiece without deformation of the workpiece.

### 2. Description of the Related Art

In general, since a workpiece is cut or moved while the workpiece is fixed and clamped, various modifications of the fixing clamp are required according to shapes of the workpiece and working environments. In addition, various modifications of the applied clamp are required according to the shape and slope of the workpiece.

The clamp refers to a structure for clamping the workpiece from a facing pair sides or one side, and the workpiece may have a risk of deformation or damage since a work for a heavy workpiece is required to be performed while the workpiece is pressed and fixed at high pressure. Accordingly, the clamp is required to have the high durability, and be formed of a material having the high hardness. Recently, swivel pads are used in which a cover is rotatable while surrounding a spherical head portion compresses and clamps the workpiece. The cover is required to be replaced due to deformation and breakage thereof.

The technology disclosed in Korean Patent Publication No. 2011-0032408 in relation to the swivel pad includes a connection portion coupled to a clamp, a flange portion protruding outward on an upper end of the connection portion, a spherical head portion fixedly coupled to an upper surface of the flange, and a cover portion formed therein with a spherical part so as to be rotatably coupled to the head portion, wherein the cover portion surrounding the head portion is naturally rotated when a workpiece is inserted, so that the workpiece supplied at various angles may be accurately fixed without deformation. However, the cover may be easily deformed or damaged by the clamping pressure applied to the head portion. The rotated cover may fail to automatically return to a reference point due to a shape of the workpiece, and thus may be required to be manually returned, and the workpiece may be damaged upon clamping the cover and the workpiece when the cover is not returned.

In addition, in an aspect of the above problems, Korean Patent Publication No. 2019-0027082 discloses a swivel pad provided with a compression spring at a rear side of a rotary pressurizing member serving as a cover portion surrounding a spherical head portion to return the rotary pressurizing member to a reference point.

However, according to the above structure of the conventional swivel pad, since the cover serving as a housing is seated on a ball to allow the cover to directly compress a workpiece, a force compressed to the cover is concentrated at an end of the ball, and accordingly, the thin cover may be easily broken or deformed.

Although the cover portion may return to the reference point by installing a compression spring formed under the cover, a diameter of a lower end of a rotary support portion is smaller than a diameter of the rotary support portion, and accordingly a weak neck part of the rotary support portion may be bent or damaged when an inclined surface of the workpiece is compressed.

In addition, the swivel pads for returning to the reference point are rarely used in the related field due to various problems. However, demands for swivel pads for returning to the reference point are increasing in industrial sites to machine or move a workpiece by fixing or supporting the workpiece from various angles.

### DOCUMENTS OF RELATED ART

Korean Patent Publication No. 10-2011-0032408 (Mar. 30, 2011) entitled by “TOGGLE JAW AND MANUFACTURING METHOD THEREOF”

Korean Patent Registration No. 10-2020820 (Sep. 4, 2019) entitled by “SWIVEL PAD FOR AUTOMATICALLY RETURNING TO REFERENCE POINT AND GRIPPER DEVICE INCLUDING SAME”

Korean Patent Publication No. 10-2019-0060728 (Jun. 3, 2019) entitled by “WORKPIECE CLAMPING DEVICE”

### SUMMARY OF THE INVENTION

In order to solve the above-described conventional problems, an object of the present invention is to provide a swivel pad capable of automatically returning to a reference point, in which a compression ball formed of bearing steel directly presses a workpiece when clamping the workpiece to fix or move the workpiece so as to clamp a heavy workpiece, and the rotated compression ball, upon unclamping, returns to the reference point and be constantly kept horizontal so as to clamp the workpiece without a damage.

Another object of the present invention is to provide a swivel pad capable of automatically returning to a reference point to prevent a damage or breakage to a workpiece by preventing an infinite rotation of a compression ball due to a breakage during long operation of a tension coil spring serving as an elastic member.

A still another object of the present invention is to provide a swivel pad capable of automatically returning to a reference point to have a structure for adjusting a height of a compression ball in response to a height of a workpiece.

The swivel pad capable of automatically returning to a reference point, in which the swivel pad is fastened to one end surface of a clamp to fix or move a workpiece, according to the present invention to solve the above-described technical problems includes: a compression ball configured to have top and bottom surfaces processed to be flat and have a first elastic body insertion hole formed at a center of the bottom surface and having a predetermined depth; a support member configured to have one side in which an insertion groove for accommodating the compression ball is formed, and a first return space and a second elastic body insertion hole having a predetermined depth in a center of the first return space are formed below the insertion groove, and configured to have an opposite side formed with a connection portion connected to a clamp; and an elastic member having ends inserted into the first elastic body insertion hole and the second elastic body insertion hole, respectively, to support the compression ball, wherein the top surface of the compression ball compresses the workpiece to fix or move the workpiece, the rotated compression ball returns horizontally after the compression is released.

The present invention configured in the above manner has advantageous effects as follows.

First, the compression ball is used so that the workpiece can be clamped and fixed and a heavy workpiece can be moved. In other words, a force can be concentrated on the bearing ball by compressing the workpiece by the compression ball formed of bearing steel, so that the heavy workpiece requiring compression at high pressure can be moved.

Second, the elastic member is accommodated in the compression ball and the support member to enable the compression ball to automatically return to the reference point after rotation, so that workpieces having various external shapes can be used.

Third, the step-shaped rotation prevention step is formed, so that the compression ball can be prevented from being rotated by a predetermined angle or more. Accordingly, the tensile coil spring is prevented from being excessively bent, so that a lifespan can extend. In addition, even when the tension coil spring is damaged due to long use, the compression ball is prevented from being infinitely rotated, so that a damage or accident to the workpiece can be prevented.

Fourth, the height of the compression ball may be adjusted according to the degree of fastening of the support member fastened inside the housing, so that the compression ball can be used according to the height of the workpiece. In addition, when a fatigue failure occurs due to accumulated fatigue in the tension coil spring due to long operation, only the swivel pad (the support member and the compression ball) can be removed from the housing and replaced.

Fifth, the workpiece can be processed at any angle thereof. When various angle rotations or a large angle rotation of the compression ball is required, a structure without a rotation prevention step can be selected and used, because the upper edge of the support member can limit the excessive rotation even when the rotation prevention step is absent.

### BRIEF DESCRIPTION OF THE DRAWINGS

FIG. 1 is a sectional view showing a conventional swivel pad for returning to a reference point.

FIG. 2 is a perspective view showing a swivel pad for returning to a reference point according to one embodiment of the present invention.

FIG. 3 is an assembly diagram of parts of the present invention shown in FIG. 2.

FIG. 4 is a sectional view showing a compression ball according to one embodiment of the present invention.

FIG. 5 is a sectional view taken along line A-A of present invention shown in FIG. 2.

FIG. 6 is a sectional view a swivel pad capable of automatically returning to a reference point according to another embodiment of the present invention shown in FIG. 5.

FIG. 7 shows operating states of the present invention shown in FIG. 6.

FIG. 8 is a sectional view showing a swivel pad capable of automatically returning to a reference point according to another embodiment of the present invention.

FIG. 9 is a sectional view showing another embodiment of the present invention shown in FIG. 8.

FIG. 10 is a sectional view showing another embodiment of the present invention shown in FIG. 6.

FIG. 11 is a sectional view showing a still another embodiment of the present invention shown in FIG. 8.

FIG. 12 is a sectional view showing a still another embodiment of the present invention shown in FIG. 9.

FIG. 13 is a sectional view showing a swivel pad capable of automatically returning to an initial position according to another embodiment of the present invention.

FIG. 14 is a sectional view showing another embodiment of the present invention shown in FIG. 13.

### DETAILED DESCRIPTION OF THE INVENTION

Hereinafter, one embodiment according to the present invention will be described in detail with reference to the accompanying drawings.

For the reference, the description with reference to the drawings is provided to understand the present invention more easily, and the scope of the present invention is not limited thereto. Further, when it is determined that the detailed description of the related known technology may unnecessarily make the subject matter of the present invention unclear in the following description of the present invention, a detailed description will be omitted.

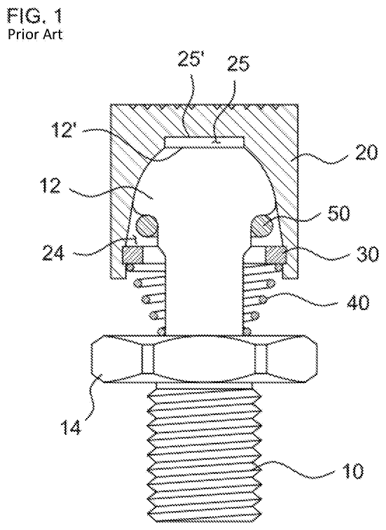

FIG. 1 is a sectional view showing a conventional swivel pad for returning to a reference point.

The present invention is configured to be fastened to one side of a clamp to fix or move a workpiece, and relates to a swivel pad in which an upper surface of a compression ball is pressed against a surface of the workpiece to fix the workpiece.

Particularly, the present invention relates to a swivel pad in which, when an external shape of the workpiece is not a planar shape, a top surface of the compression ball is compressed while rotating so as to be horizontal to the surface of the workpiece according to the external shape of the workpiece, and the top surface of the compression ball of the swivel pad may automatically return in a horizontal direction as a reference point when the pressing of the swivel pad is released after moving the workpiece.

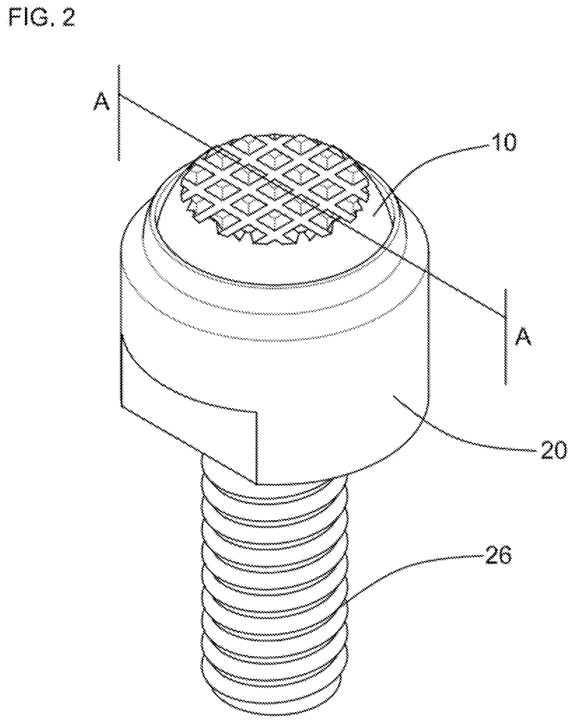

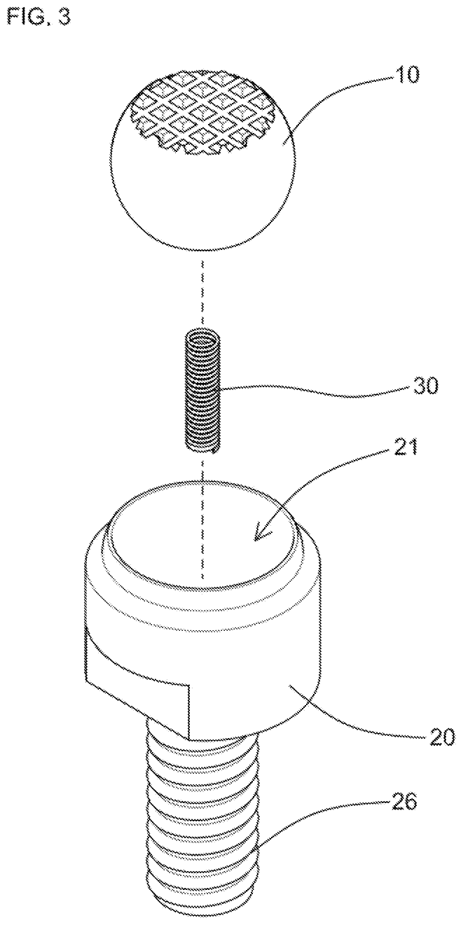

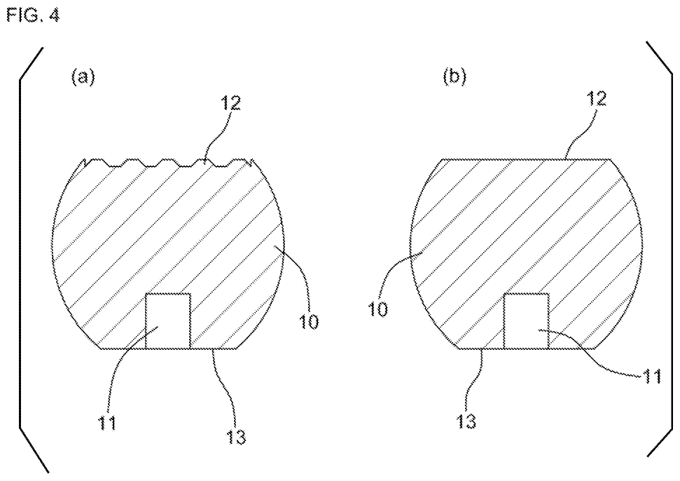

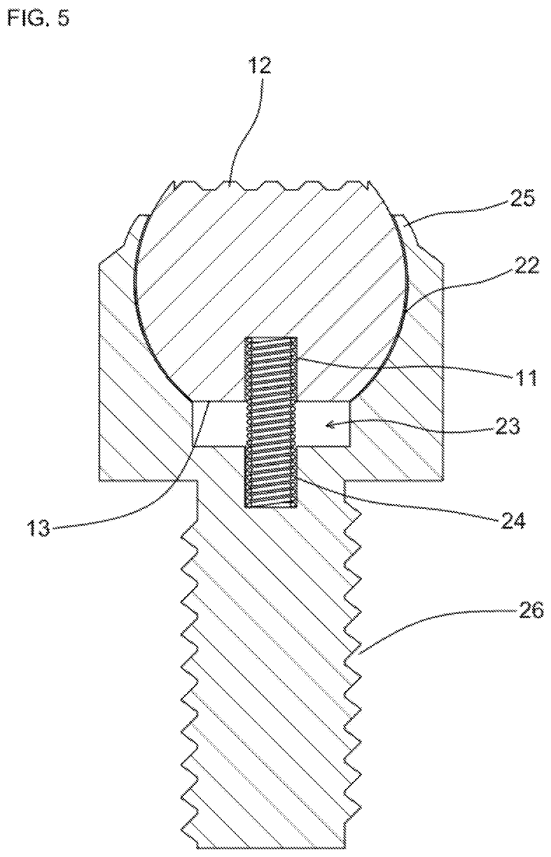

For the reference, it is noted that the term ‘swivel pad’ in the present invention refers to a device fastened to both side end surfaces of a pair of facing clamps, which may fix a workpiece to move the workpiece, so as to compress and fix the workpiece, and includes a toggle jaw and a fixing chuck. Hereinafter, the present invention will be described in detail with reference to FIGS. 2 to 5. FIG. 2 is a perspective view showing a swivel pad for returning to a reference point according to one embodiment of the present invention. FIG. 3 is an assembly diagram of parts of the present invention shown in FIG. 2. FIG. 4 is a sectional view showing a compression ball according to one embodiment of the present invention. FIG. 5 is a sectional view taken along line A-A of present invention shown in FIG. 2.

Referring to the shown drawings, the present invention may mainly include a compression ball 10, a support member 20, and an elastic member 30.

First, the compression ball 10 will be described.

The compression ball 10 has a shape obtained by cutting predetermined portions of a top surface 12 and a bottom surface 13 of a bearing ball and processing the cut portions to be flat.

In addition, since the compression ball 10 is directly compressed to the workpiece at high pressure when fixing or moving a heavy workpiece, a damage or deformation to the compression ball 10 may be prevented only when the hardness is HRC60 or higher as a bearing steel.

In addition, the top surface 12 of the compression ball 10 is a portion coming into close contact with the workpiece to fix the workpiece. A diamond type having irregularities formed on the top surface may be selected when a surface of the workpiece is irregular as shown in FIG. 4(a), or a flat type may be selected when the surface of the workpiece is flat as shown in FIG. 4(b).

In addition, a first elastic body insertion hole 11 into which the elastic member 30 may be inserted is formed in a center of the bottom surface 13 of the compression ball 10. The elastic member 30 may be inserted into the first elastic body insertion hole 11 at a predetermined depth or more to prevent the elastic member 30 from being easily separated, and may be seated on the support member 20 while being inserted.

Next, the support member 20 is formed at one side thereof with an insertion groove 21 for accommodating the compression ball 10, in which a first return space 23 is formed under the insertion groove 21, and a second elastic body insertion hole 24 is formed in a center of the first return space 23 to have a predetermined depth, and formed at the other side with a connection portion 26 fastened to a clamp.

The insertion groove 21 has an inner surface 22 formed in a sphere shape identical to an outer shape of the compression ball 10 to rotatably seat the compression ball 10.

In addition, after the compression ball 10 is inserted therein while an upper portion of the insertion groove 21 is opened, an upper edge 25 is press-fitted, so that the compression ball 10 is prevented from being separated from the insertion groove 21.

Importantly, it is preferable that the free rotation angle of the compression ball 10 is a predetermined angle or less within the insertion groove 21. When the compression ball 10 is rotated at the predetermined angle, the compression ball 10 in close contact with the workpiece may slip. Therefore, it is preferable to have a structure such that the free rotation angle of the compression ball 10 is within 20°.

In addition, the elastic member 30 is accommodated in a center of a lower side of the insertion groove 21, so that a first return space 23 serving as a space for securing a flexibility to the elastic member 30 is formed, and a second elastic body insertion hole 24 is formed in a center of a bottom of the first return space 23.

The second elastic body insertion hole 24 is a hole having a depth and an inner diameter such that a part of the elastic member 30 is inserted by a predetermined depth and is not easily removed. Accordingly, one end of the elastic member 30 is fitted into the first elastic body insertion hole 11 and the other end is fitted into the second elastic body insertion hole 24.

Since it is preferable that the depth of the first return space 23 is formed within a predetermined length range. The depth may be 1 mm to 10 mm, but 2 mm to 8 mm may be preferable to facilitate the return to the reference point of the compression ball 10 smoothly. In the case of 1 mm or less, the elastic member 30 may be bent because a deformation space of the elastic member 30 is small, thereby causing difficulty in rotation of the compression ball 10. In the case of 10 mm or more, the speed decreases because the return of the rotated compression ball 10 is slow.

Preferably, the depth of the first return space 23 may be set in a range of the number of exposed wound turns of a tension coil spring, instead of the above-described length.

More specifically, the elastic member 30 may use a tension coil spring, and both ends thereof are inserted and installed to the first elastic body insertion hole 11 and the second elastic body insertion hole 24, respectively.

The remaining portion other than the inserted portion is exposed to the outside, in which a length of the exposed portion H is equal to the depth of the first return space 23.

Preferably, the length of the exposed portion H may correspond to 6 to 8 turns based on the number of turns of the tension coil spring, that is, the number of wound turns.

When the number of turns of the exposed portion H is less than 6, a space for enabling the tension coil spring to be freely deformed may become narrow, thereby causing the tension coil spring to be bent, and accordingly, the rotation of the compression ball 10 may not be smoothly performed.

In contrast, when the number of turns of the exposed portion H is greater than 8, the return of the rotated compression ball 10 may be delayed, thereby decreasing a speed.

Meanwhile, a connection portion 26 capable of fastening the swivel pad to one end surface of the clamp is formed on the other side of the support member 20.

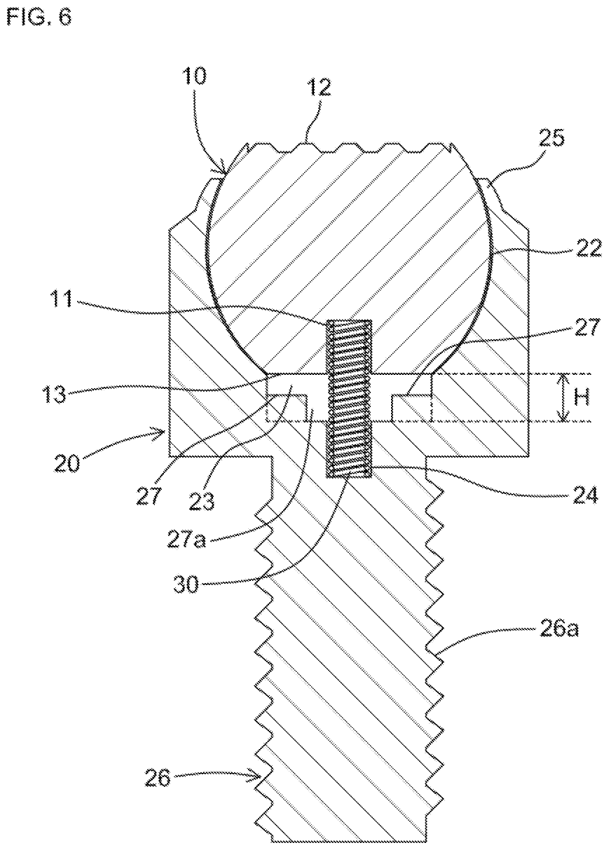

As shown in FIG. 6, the connection portion 26 may be a bolt 26a type with a male thread or a tap hole 26b type with a female thread. The tap hole 26b type will be described in detail later.

Next, the elastic member 30 is inserted into the first elastic body insertion hole 11 of the compression ball 10 and the second elastic body insertion hole 24 of the support member 20, so as to return the rotated compression ball 10 to the reference position while elastically supporting the compression ball 10.

The elastic member 30 may be formed of synthetic resin or metal having elasticity, and may be formed of a rubber material. It is preferable to use a tension coil spring. Therefore, one end of the tension coil spring is inserted into the first elastic body insertion hole 11 and the other end is inserted into the second elastic body insertion hole 24, so that the tension coil spring may elastically support the compression ball 10.

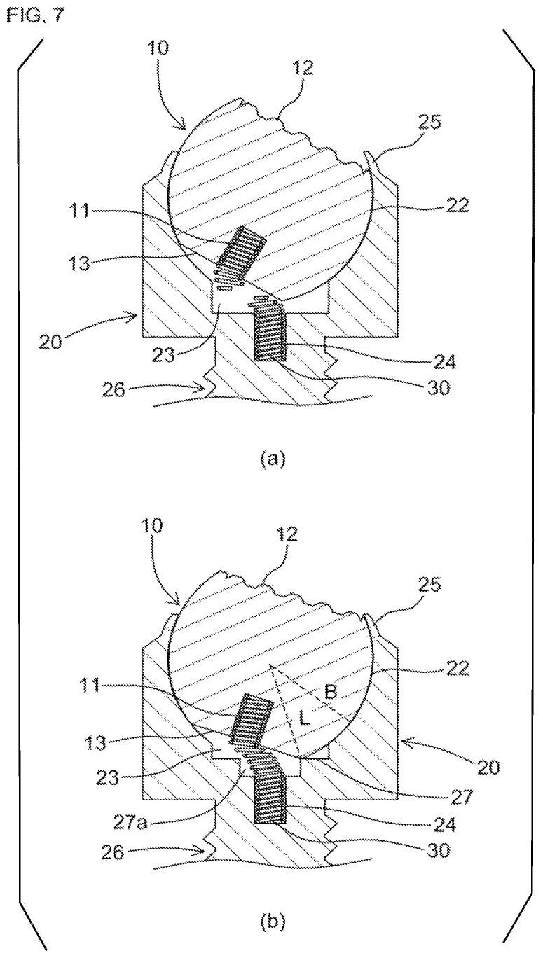

Hereinafter, another embodiment of the present invention will be described with reference to FIGS. 6 and 7 together. FIG. 6 is a sectional view showing another embodiment of the present invention shown in FIG. 5, and FIG. 7 is a comparison diagram of an operating state of the present invention shown in FIG. 6. FIG. 7(a) shows a case without a rotation prevention step, and FIG. 7(b) shows a case with the rotation prevention step.

The another embodiment of the present invention has a structure further including a rotation prevention step for limiting the rotation of the compression ball 10 in the first return space of the present invention.

In general, the automatic swivel pad as a kind of expendable product returns to the reference point by the tension coil spring. However, as shown in FIG. 7(a), when a fatigue failure occurs in the tension coil spring due to a long operation, the compression ball may be rotated infinitely.

Since the continuous clamping the workpiece in the above state may cause a damage or defect in the workpiece due to the infinite rotation of the compression ball, the rotation prevention step 27 is required to prevent the damage of the workpiece by preventing the compression ball 10 from being rotated at the predetermined angle or more.

The rotation prevention step 27 has a stepped shape along an edge in the first return space 23.

Accordingly, since the cut bottom surface 13 of the compression ball 10 is latched to the rotation prevention step 27 even when the compression ball 10 is rotated within the first return space 23, the compression ball 10 may be prevented from being rotated by the predetermined angle or more.

More specifically, a length L from a center of the compression ball 10 to an inner upper corner of the rotation prevention step 27 is formed to be smaller than a radius B of the compression ball 10, so that the compression ball 10 may be latched to the rotation prevention step 27.

Due to the rotation prevention step 27, a third return space 27a having a hole shape is formed in a lower portion of the first return space 23, that is, in a center of the rotation prevention step 27.

The third return space 27a forms a free space to prevent the compression ball 10 from colliding or contacting with the rotation prevention step 27 while the tension coil spring serving as the elastic member 30 is tilted and tensioned when the compression ball 10 is rotated.

To this end, an inner diameter of the third return space 27a may be formed larger than an inner diameter of the second elastic body insertion hole 24.

Accordingly, even when the compression ball 10 is rotated, the tension coil spring serving as the elastic member 30 does not collide or contact with the rotation prevention step 27, so that a lifespan of the tension coil spring is secured.

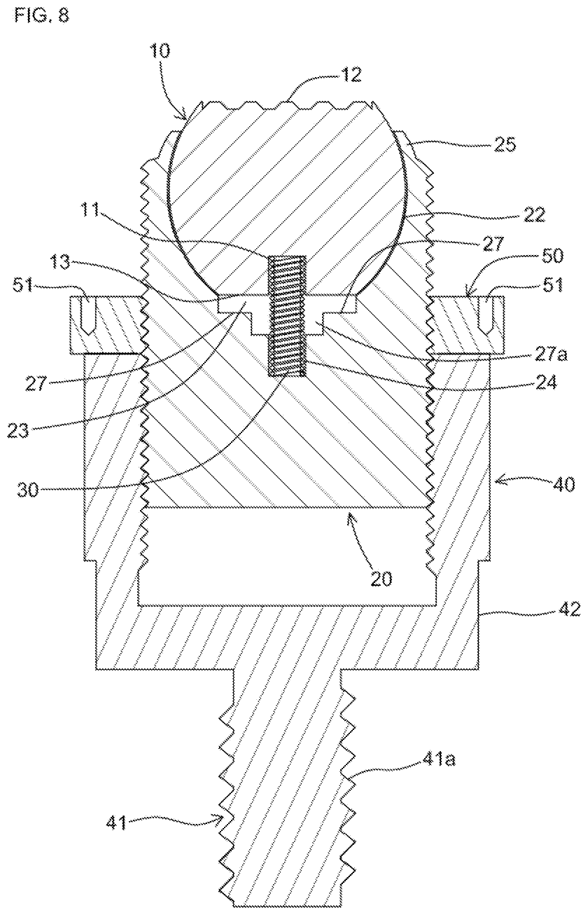

Hereinafter, another embodiment of the present invention will be described with reference to FIG. 8. FIG. 8 is a sectional view showing a swivel pad capable of automatically returning to an initial position according to another embodiment of the present invention.

Another embodiment of the present invention may have a structure in which the swivel pad has a height adjusted according to a height of the workpiece, instead of being simply connected to the clamp. As shown in FIG. 8, the present invention having the above structure may be configured to mainly include a compression ball 10, a support member 20, an elastic member 30, a housing 40, and a locking nut 50.

Since the compression ball 10 and the elastic member 30 have the structure similar to the above-described structure, the detailed description will be omitted, and the support member 20, the housing 40, and the locking nut 50 will be described in detail.

However, the insertion groove 21 formed at one side of the support member 20 to accommodate the compression ball 10, the structure with an open top, the first return space and the second elastic body insertion hole, and the rotation prevention step formed in the first return space are the same as the above-described descriptions.

However, a male thread is formed on the outer circumferential surface of the support member 20.

The male thread of the support member 20 is configured to be screwed with the housing 40 described later.

Next, the housing 40 is configured to be screwed with the support member 20 while accommodating the support member 20, have a hollow shape and have a female thread formed on an inner circumferential surface thereof. Accordingly, a lower end of the support member 20 may be inserted into the housing 40 and screwed with the housing 40.

In addition, a connection portion 41 connected and fastened to one end surface of the clamp is formed in a lower portion of the housing 40. As shown in the drawings, the connection portion 41 may be a bolt 41a type formed thereon with a male thread.

In addition, a tightening portion 42 may be formed at a lower end of the housing 40 to tighten the housing 40 using a wrench or a spanner.

Next, the locking nut 50 is fastened to the outer circumferential surface of the support member 20 and fastened to be in close contact with an upper end of the housing 40 so as to fix the support member 20 fastened to the housing 40.

In other words, the support member 20 is locked so as not to be rotated in the housing 40.

At least one wrench hole 51 is formed at one side of the locking nut 50.

Accordingly, when the support member 20 is rotated forward or backward while the connection part 41 is connected to the clamp, the support member 20 may move in-out inside the housing 40, so that the heights of the support member 20 and the compression ball may be adjusted to compress the compression ball to the workpiece.

In addition, when the height of the support member 20 is determined, the locking nut 50 is locked to fix the support member 20 so as to prevent the rotation thereof.

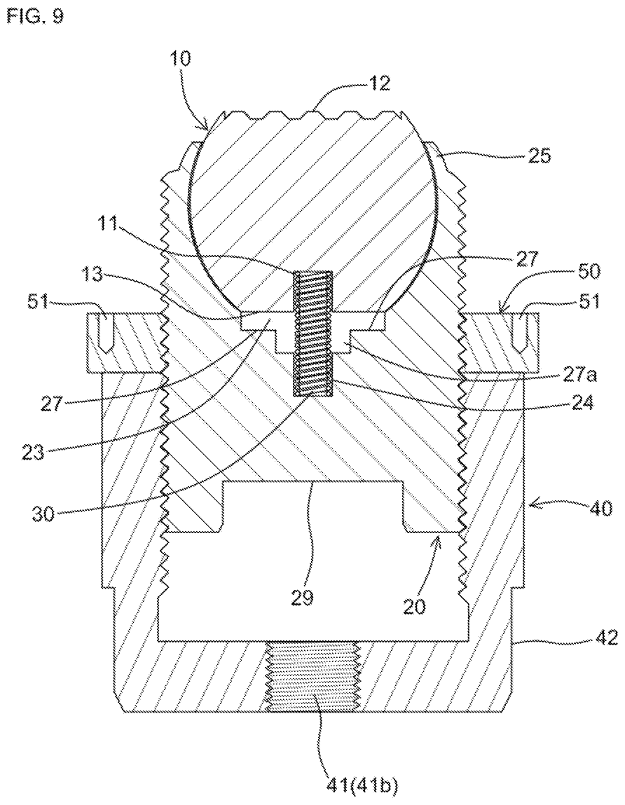

Hereinafter, another embodiment of the present invention will be described with reference to FIG. 9.

FIG. 9 is a sectional view showing a still another embodiment of the present invention shown in FIG. 8.

As shown in FIG. 9, the still another embodiment of the present invention shows a state in which the connection portion of the housing has a different structure.

The connection portion 41 formed at a lower portion of the housing 40 may be a tap hole 41b. In other words, the connection portion 41 may be a tab hole 41b type in which the lower bottom of the housing 40 is vertically formed through and has a female thread formed on an inner circumferential surface thereof.

In addition, an interference prevention groove 29 may be formed on a lower surface of the support member 20 to prevent a collision or interference with a bolt of the clamp passing through and fastened to the tap hole 41b.

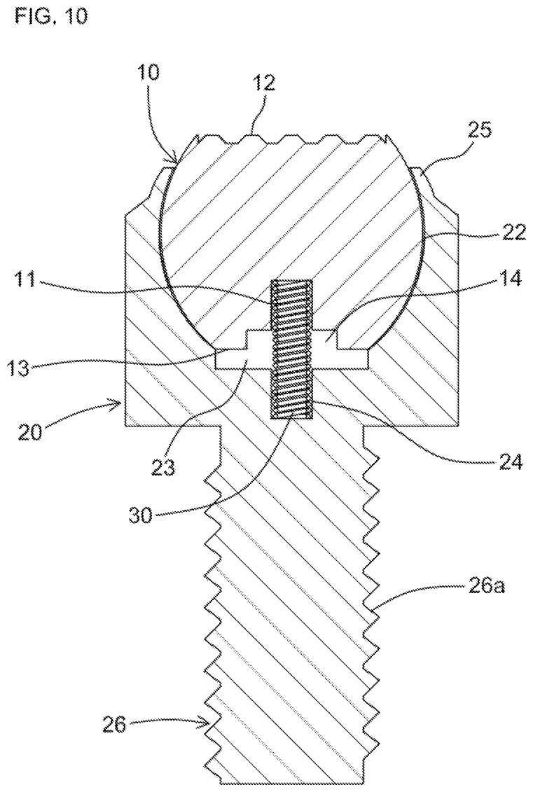

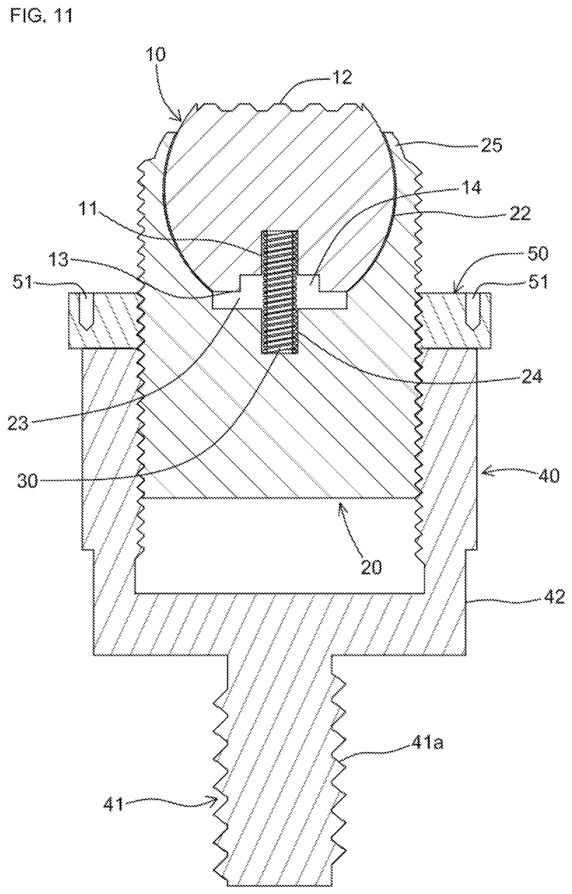

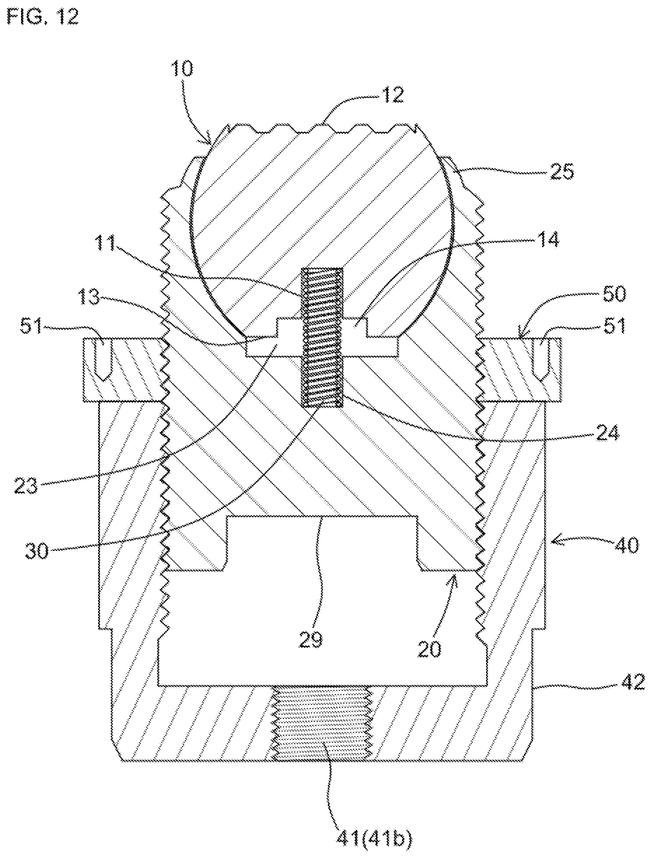

A still another embodiment of the present invention will be further described with reference to FIGS. 10 to 12. FIG. 10 is a sectional view showing another embodiment of the present invention shown in FIG. 6. FIG. 11 is a sectional view showing a still another embodiment of the present invention shown in FIG. 8. FIG. 12 is a sectional view showing a still another embodiment of the present invention shown in FIG. 9.

The still another embodiment of the present invention shown in FIG. 10 includes a compression ball 10, a support member 20, and an elastic member 30, and the support member 20 and the elastic member 30 have the structure the same as the above-described structure, so the detailed description will be omitted.

However, the compression ball 10 has a structure in which a concave second return space 14 is further formed on the flat bottom surface 13.

The first elastic body insertion hole 11 is formed in the center of the second return space 14 to have a predetermined depth.

Accordingly, the second return space 14 is a space formed in a circular shape while surrounding an outer side of the first elastic body insertion hole 11.

The second return space 14 secures a space for enabling the elastic member 30 to move when the first return space 23 is narrow.

Likewise, the length of the exposed portion of the tension coil spring inserted into the first elastic body insertion hole 11 and the second elastic body insertion hole 24 may be 6 turns to 8 turns based on the number of turns of the tension coil spring, that is, the number of wound turns.

The bottom surface of the first return space 23 may serve as the above-described rotation prevention step for limiting the rotation of the compression ball 10.

The still another embodiments of the present invention shown in FIGS. 11 and 12 include a compression ball, a support member 20, an elastic member 30, a housing 40, and a locking nut 50, and the support member 20, the elastic member 30, the housing 40, and the locking nut 50 have the structure the same as the above-described structure, so the detailed description will be omitted.

However, the compression ball 10 also has a structure as in FIG. 10 in which a concave second return space 14 is further formed on a flat bottom surface.

In addition, since the first elastic body insertion hole 11 is formed in the center of the second return space 14 to have a predetermined depth, the second return space 14 is a space formed in a circular shape while surrounding an outer side of the first elastic body insertion hole 11.

The second return space 14 secures a space for enabling the elastic member 30 to move when the first return space 23 is narrow.

Likewise, the length of the exposed portion of the tension coil spring inserted into the first elastic body insertion hole 11 and the second elastic body insertion hole 24 may be 6 turns to 8 turns based on the number of turns of the tension coil spring, that is, the number of wound turns.

Likewise, the bottom surface of the first return space 23 may serve as the above-described rotation prevention step for limiting the rotation of the compression ball 10.

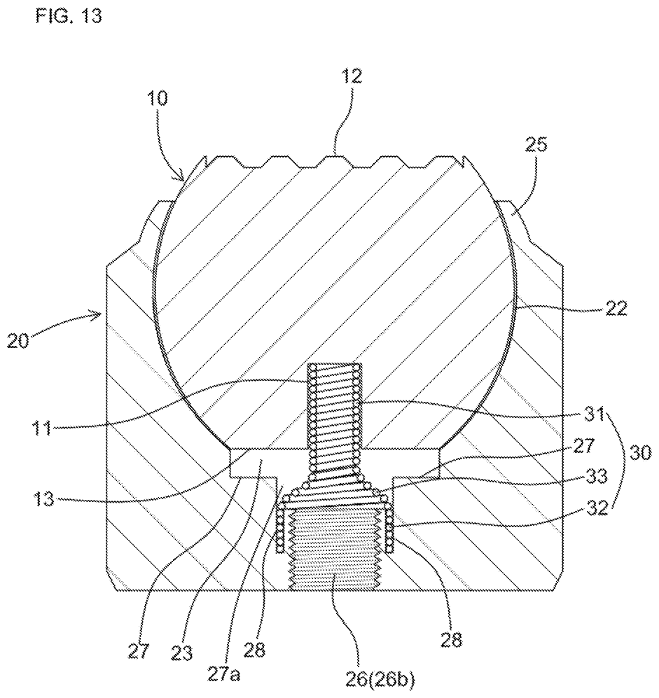

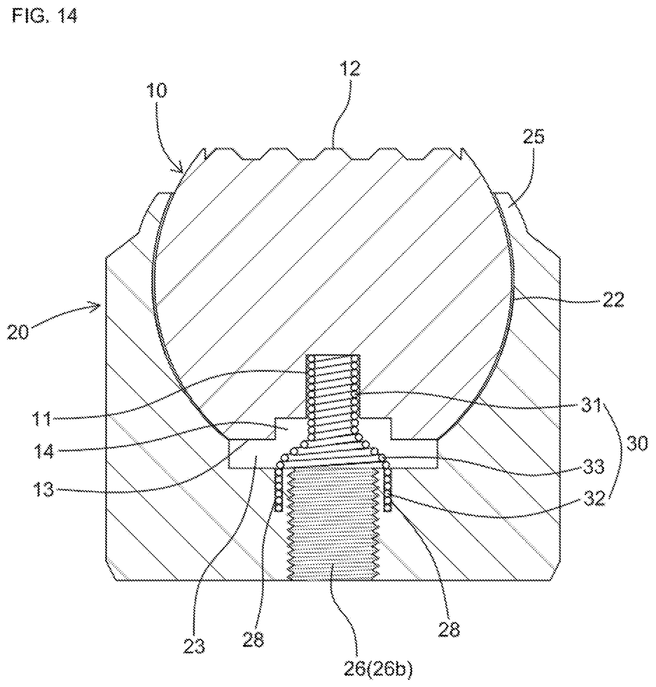

FIG. 13 is a sectional view showing a swivel pad capable of automatically returning to an initial position according to another embodiment of the present invention. FIG. 14 is a sectional view showing another embodiment of the present invention shown in FIG. 13.

Referring to the shown in FIG. 13, the still another embodiment of the present invention may mainly include a compression ball 10, a support member 20, an elastic member 30.

First, since the structure and shape of the compression ball 10 have the structure similar to the above-described structure, the detailed description will be omitted.

Next, the support member 20 has a spherical insertion groove 21 formed on one side thereof as described in the above manner, and a first return space 23 and a third return space 27a are formed below the insertion groove 21. In addition, the other side of the support member 20 is formed with a connection portion 26 that may be connected to the clamp.

However, the connection portion 26 may be a tap hole 26b type in which a lower portion of the support member 20, specifically, the bottom of the third return space 27a is vertically formed through and has a female thread formed on an inner circumferential surface thereof.

In addition, a third elastic body insertion groove 28 is formed in the bottom of the third return space 27a.

The third elastic body insertion groove 28 may have a shape surrounding the tab hole 26b type in a circular shape. In other words, an inner diameter of the third elastic body insertion groove 28 is formed larger than an outer diameter of the tap hole 26b, and formed larger than an inner diameter of the first elastic body insertion hole 11.

In addition, a width of the third elastic body insertion groove 28 is slightly larger than a wire diameter of the coil spring, so that the coil spring is inserted and fitted with almost no gap.

Next, a tension coil spring may be used as the elastic member 30. As shown in the drawings, the tensile coil spring may have a shape including a first coil part 31, a second coil part 32, and a third coil part 33 having different outer diameters.

The first coil part 31 has a shape having a predetermined outer diameter so as to be inserted and fitted into the first elastic body insertion hole 11, and the second coil unit 32 has a shape having a predetermined outer diameter so as to be inserted and fitted into the third elastic body insertion groove 28.

The outer diameter of the second coil part 32 is larger than the outer diameter of the first coil part 31.

In addition, the third coil part 33, which connects the first coil part 31 to the second coil part 32, may have an outer diameter expanded in a conical shape or a bell shape to connect different outer diameters to each other.

Another embodiment shown in FIG. 14 has a structure in which the second return space 14 is formed in the compression ball 10.

In other words, a first return space 23 is formed below the insertion groove 21 of the support member 20, the tap hole 26b is formed at the bottom of the first return space 23 without the third return space 27a, and the third elastic body insertion groove 28 is formed in a circular shape around the tap hole 26b.

The second return space 14 secures a space for enabling the elastic member 30 to move when the first return space 23 is narrow.

The exemplary embodiments of the present invention has been described with reference to the drawings. However, it will be apparent that a person having ordinary skill in the art may carry out various applications and modifications based on the above description within the scope without departing from inherent features of the present invention. Therefore, the scope of the present invention should not be limited to the aforementioned embodiments, and should be determined by the following claims and the equivalent thereof.

What is claimed is:

1. A swivel pad capable of automatically returning to a reference point, in which the swivel pad is fastened to one end surface of a clamp to fix or move a workpiece, the swivel pad comprising:
a compression ball configured to have top and bottom surfaces processed to be flat and have a first elastic body insertion hole formed at a center of the bottom surface and having a predetermined depth;
a support member configured to have one side in which an insertion groove for accommodating the compression ball is formed, and a first return space and a second elastic body insertion hole having a predetermined depth in a center of the first return space are formed below the insertion groove, and configured to have an opposite side formed with a connection portion connected to a clamp; and
an elastic member having ends inserted into the first elastic body insertion hole and the second elastic body insertion hole, respectively, to support the compression ball, wherein
the top surface of the compression ball compresses the workpiece to fix or move the workpiece, and
the rotated compression ball returns horizontally after the compression is released.

2. The swivel pad of claim 1, wherein the elastic member is a coil-shaped tension coil spring.

3. The swivel pad of claim 2, wherein a length of an exposed portion, in which the tension coil spring is exposed without being inserted into the first elastic body insertion hole and the second elastic body insertion hole, corresponds to 6 to 8 turns of the tension coil spring.

4. The swivel pad of claim 1, wherein a stepped-shaped rotation prevention step is formed on an inner circumferential surface of the first return space to limit the rotation of the compression ball by a predetermined angle or more.

5. The swivel pad of claim 4, wherein a length from a center of the compression ball to an inner upper corner of the rotation prevention step is smaller than a radius of the compression ball.

6. The swivel pad of claim 1, wherein the connection portion is a bolt type that protrudes from an opposite side of the support member and formed thereon with a male thread, or a tap hole type that extends by passing through the opposite side of the support member and formed with a female thread on an inner circumferential surface thereof.

7. The swivel pad of claim 1, wherein a concave second return space surrounding an outer side of the first elastic body insertion hole is formed on a lower surface of the compression ball, and the first elastic body insertion hole is formed in a center of the second return space.

8. A swivel pad capable of automatically returning to a reference point, in which the swivel pad is fastened to one end surface of a clamp to fix or move a workpiece, the swivel pad comprising:
a compression ball configured to have top and bottom surfaces processed to be flat and have a first elastic body insertion hole formed at a center of the bottom surface and having a predetermined depth; and
a support member configured to have one side in which an insertion groove for accommodating the compression ball is formed, and a first return space and a second elastic body insertion hole having a predetermined depth in a center of the first return space are formed below the insertion groove, and configured to have a male thread formed on an outer circumferential surface of the support member;
an elastic member having ends inserted into the first elastic body insertion hole and the second elastic body insertion hole, respectively, to support the compression ball;
a housing formed on a hollow inner circumferential surface thereof with a female thread so as to be screwed with the male thread of the support member, and formed at a lower portion thereof with a connection portion connected to a clamp; and
a locking nut fastened to the outer circumferential surface of the support member to fix the support member to the housing; wherein
the top surface of the compression ball compresses a workpiece to fix or move the workpiece, the rotated compression ball returns horizontally after the compression is released, and
a height of the compression ball is adjusted according to a fastening degree of the support member fastened to the housing.

9. The swivel pad of claim 8, wherein the elastic member is a coil-shaped tension coil spring.

10. The swivel pad of claim 9, wherein a length of an exposed portion, in which the tension coil spring is exposed without being inserted into the first elastic body insertion hole and the second elastic body insertion hole, corresponds to 6 to 8 turns of the tension coil spring.

11. The swivel pad of claim 8, wherein a stepped-shaped rotation prevention step is formed on an inner circumferential surface of the first return space to limit the rotation of the compression ball by a predetermined angle or more.

12. The swivel pad of claim 11, wherein a length from a center of the compression ball to an inner upper corner of the rotation prevention step is smaller than a radius of the compression ball.

13. The swivel pad of claim 8, wherein the connection portion is a bolt type that protrudes from an opposite side of the support member and formed thereon with a male thread, or a tap hole type that extends by passing through the opposite side of the support member and formed with a female thread on an inner circumferential surface thereof.

14. The swivel pad of claim 8, wherein a concave second return space surrounding an outer side of the first elastic body insertion hole is formed on a lower surface of the compression ball, and the first elastic body insertion hole is formed in a center of the second return space.

15. A swivel pad capable of automatically returning to a reference point, in which the swivel pad is fastened to one end surface of a clamp to fix or move a workpiece, the swivel pad comprising:
a compression ball configured to have top and bottom surfaces processed to be flat and have a first elastic body insertion hole formed at a center of the bottom surface and having a predetermined depth;
a support member having one side in which an insertion groove for accommodating the compression ball is formed and a first return space is formed below the insertion groove, and an opposite side formed with a connection portion connected to the clamp, in which a third elastic body insertion groove is formed around the connection portion in the first return space; and
an elastic member having ends inserted into the first elastic body insertion hole and the third elastic body insertion hole, respectively, to support the compression ball, wherein
the top surface of the compression ball compresses the workpiece to fix or move the workpiece, and the rotated compression ball returns horizontally after the compression is released, and wherein
the elastic member includes a first coil part inserted into the first elastic body insertion hole, a second coil part inserted into the third elastic body insertion groove and having an outer diameter larger than an outer diameter of the first coil part, and a third coil part having a conical shape to connect the first coil part to the second coil part.

16. The swivel pad of claim 15, wherein a concave second return space surrounding an outer side of the first elastic body insertion hole is formed on a lower surface of the compression ball, and the first elastic body insertion hole is formed in a center of the second return space.

17. The swivel pad of claim 15, wherein the connection portion is a tap hole type that extends by passing through the opposite side of the support member and formed with a female thread on an inner circumferential surface thereof.
